(19) United States
(12) Patent Application Publication
(10) Pub. No.: US 2024/0247963 A1
(43) Pub. Date: Jul. 25, 2024

(54) CUP WITH CONCAVE MEASUREMENT WINDOWS

(71) Applicant: Olababy Incorporated, Beaverton, OR (US)

(72) Inventors: Qiao LIN, Beverly Hills, CA (US); Paul WANG, Portland, OR (US)

(21) Appl. No.: 18/415,633

(22) Filed: Jan. 17, 2024

Related U.S. Application Data
(60) Provisional application No. 63/481,076, filed on Jan. 23, 2023.

(51) Int. Cl. G01F 19/00

(52) U.S. Cl. CPC G01F 19/00

(57) ABSTRACT

A silicone cup is provided. The silicone cup includes a body made of a silicone. The silicone cup also includes a plurality of concave measurement windows provided on an exterior surface of the body.

### CROSS REFERENCE TO RELATED APPLICATION

This application claims priority to U.S. provisional application No. 63/481,076, filed on Jan. 23, 2023, the entire content of which is incorporated herein by reference.

### TECHNICAL FIELD

The present disclosure relates to the technology field of containers and, more particularly, to a cup with concave measurement windows.

### BACKGROUND

Containers such as cups are common household items people use in their daily life for storing or serving liquid, such as water, milk. Many cups are made of a non-transparent or non-translucent material, and do not have measurement scales or windows. Thus, it may be difficult to tell the level of liquid in the cup.

### SUMMARY OF THE DISCLOSURE

In accordance with an aspect of the present disclosure, a silicone cup is provided. The silicone cup includes a body made of a silicone. The silicone cup also includes a plurality of concave measurement windows provided on an exterior surface of the body.

Other aspects of the present disclosure can be understood by those skilled in the art in light of the description, the claims, and the drawings of the present disclosure.

### BRIEF DESCRIPTION OF THE DRAWINGS

The following drawings are provided for illustrative purposes according to various disclosed embodiments and are not intended to limit the scope of the present disclosure. In the drawings:

FIG. 1 is a schematic illustration of a perspective view of a silicone cup with concave measurement windows, according to an embodiment of the present disclosure;

FIG. 2 is a schematic illustration of a front view of the silicone cup with the concave measurement windows shown in FIG. 1, according to an embodiment of the present disclosure;

FIG. 3 is a schematic illustration of a cross-sectional view of the silicone cup with the concave measurement windows along the 3-3 line shown in FIG. 2, according to an embodiment of the present disclosure;

FIG. 4 is a schematic illustration of a cross-sectional view of the silicone cup with the concave measurement windows along the 4-4 line shown in FIG. 2, according to an embodiment of the present disclosure;

FIG. 5 is a schematic illustration of a perspective view of a silicone cup with concave measurement windows, according to another embodiment of the present disclosure;

FIG. 6 is a schematic illustration of a front view of the silicone cup with the concave measurement windows shown in FIG. 5, according to an embodiment of the present disclosure;

FIG. 7 is a schematic illustration of a cross-sectional view of the silicone cup with the concave measurement windows along the 7-7 line shown in FIG. 6, according to an embodiment of the present disclosure;

FIG. 8 is a schematic illustration of a cross-sectional view of the silicone cup with the concave measurement windows along the 8-8 line shown in FIG. 6, according to an embodiment of the present disclosure;

FIG. 9 is a schematic illustration of a front to perspective view of a silicone cup with concave measurement windows, according to an embodiment of the present disclosure;

FIG. 10 is a schematic illustration of a cross-sectional view of the silicone cup shown in FIG. 9, according to an embodiment of the present disclosure;

FIG. 11 is a schematic illustration of a front to perspective view of a silicone cup with concave measurement windows, according to an embodiment of the present disclosure;

FIG. 12 is a schematic illustration of a cross-sectional view of the silicone cup shown in FIG. 11, according to an embodiment of the present disclosure;

FIG. 13 is a schematic illustration of a front to perspective view of a silicone cup with concave measurement windows, according to an embodiment of the present disclosure;

FIG. 14 is a schematic illustration of a cross-sectional view of the silicone cup shown in FIG. 13, according to an embodiment of the present disclosure;

FIG. 15 is a schematic illustration of a front to perspective view of a silicone cup with concave measurement windows, according to an embodiment of the present disclosure; and

FIG. 16 is a schematic illustration of a cross-sectional view of the silicone cup shown in FIG. 15, according to an embodiment of the present disclosure.

### DETAILED DESCRIPTION

Technical solutions of the present disclosure will be described in detail with reference to the drawings, in which the same numbers refer to the same or similar elements unless otherwise specified. A person having ordinary skills in the art would appreciate that the described embodiments represent some, rather than all, of the embodiments of the present disclosure. A person having ordinary skills in the art can conceive or derive other embodiments or variations based on the described embodiments. Such embodiments also fall within the scope of the present disclosure.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

The singular forms of “a,” “an,” and “the” are intended to include the plural forms as well, unless the context indicates otherwise. The terms “comprise,” “comprising,” “include,” and the like specify the presence of stated features, steps, operations, elements, and/or components, and do not preclude the presence or addition of one or more other features, steps, operations, elements, components, and/or groups.

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” has a meaning similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include one such element. The number of elements illustrated in the drawing is for illustration purposes only, and should not be construed as limiting the scope of the embodiment. Moreover, the embodiments and/or features included in various embodiments shown in the drawings are not mutually exclusive, and they may be combined in any suitable manner. For example, elements shown in only one embodiment (or figure) may nevertheless be included in the other embodiments (or figures).

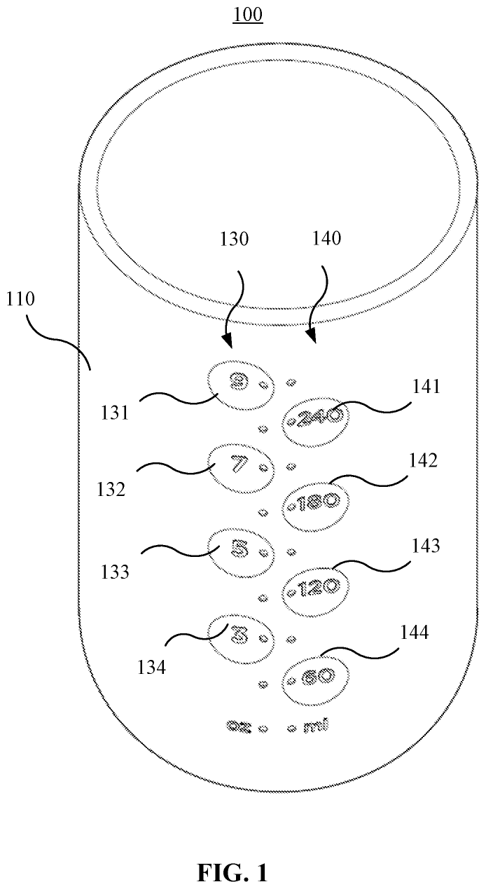

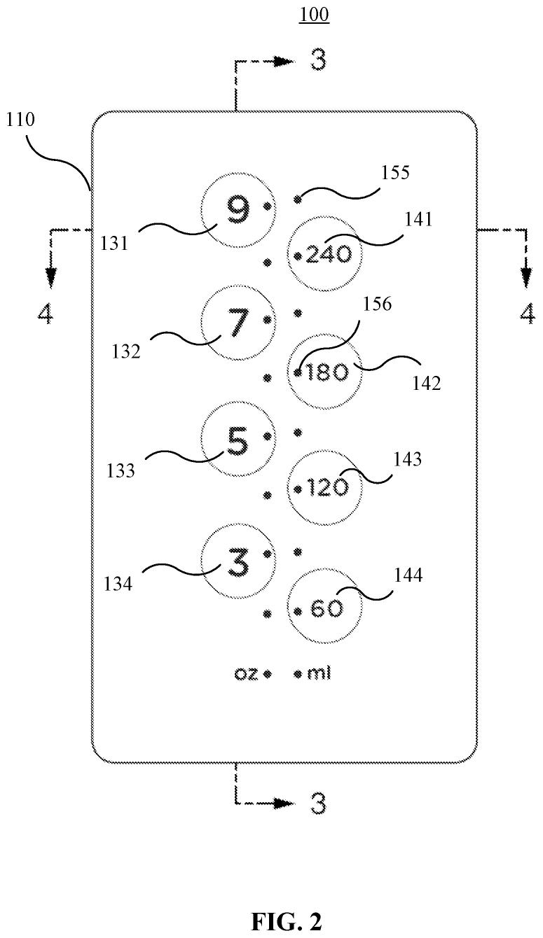

FIG. 1 is a schematic illustration of a perspective view of a silicone cup 100 having transparent, concave measurement windows, according to an embodiment of the present disclosure. FIG. 2 is a schematic illustration of a front view of the cup 100 shown in FIG. 1. The silicone cup 100 may be entirely made of silicone. In some embodiments, the entire silicone cup 100 may be transparent. In some embodiments, the entire silicone cup 100 may be translucent. In some embodiments, some portions of the silicone cup 100 may be transparent and other portions of the silicone cup 100 may be translucent. The silicone cup 100 may have a cylindrical body 110 (i.e., a body having a cylinder shape). That is, the silicone cup 100 may have a substantially same or uniform outer diameter from the bottom to the top. The silicone cup 100 may include two columns 130, 140, of transparent measurement windows formed on an exterior surface of the cylindrical body 110. A first column 130 may include a first plurality of transparent measurement windows 131-134. A second column 140 may include a second plurality of transparent measurement windows 141-144. Measurement windows included at least one of the two columns may be concave. In some embodiments, only one column of measurement windows may be concave. In some embodiments, both columns of measurement windows may be concave. Concave measurement windows are depressed from the exterior surface of the cylindrical body 110. For example, a portion of the exterior surface may be sanded away or removed through other methods, such that a concave window may be formed on the exterior surface. That is, a concave surface of the concave window is lower than other portions of the exterior surface of the cylindrical body 110. The first column 130 may be configured for measuring the liquid in the cup 100 in ounce (“oz” in FIG. 1), and the second column 140 may be configured for measuring the liquid in the cup 100 in milli-liter (“ml” in FIG. 1). Circular windows are used as examples. The windows may be in other shapes. The cup 100 may also include a plurality of solid protrusions 155, 156 to function as measurement markings. The solid protrusions may be any suitable forms or shapes, such as small dots, small balls, small tubes, small bars, etc. In the figures, dots are shown as example shapes. Each concave window may include a solid protrusion formed on and protruding from the concave surface of the concave window. In some embodiments, each solid protrusion formed on the concave surface of a concave window may still be lower than the portions of the exterior surface of the cylindrical body 110 that surround the concave window (or simply, lower than the exterior surface of the cylindrical body 110). In some embodiments, each solid protrusion formed on the concave surface of a concave window may be slightly higher than the portions of the exterior surface of the cylindrical body 110 that surround the concave window (or simply, higher than the exterior surface of the cylindrical body 110). In some embodiments, each solid protrusion formed on the concave surface of a concave window may be of substantially the same height as the portions of the exterior surface of the cylindrical body 110 that surround the concave window (or simply, of substantially the same height as the exterior surface of the cylindrical body 110). For example, in the concave measurement window 142, there is a solid protrusion dot 156 formed next to the number “180” for indicating the 180 ml marking. The solid protrusion dot 156 may be formed on the concave surface of the concave measurement window 142. As shown in FIG. 2, some protrusion dots (ones similar to 156) may be located within the measurement windows, some protrusion dots (ones similar to 155) may be located outside of the measurement windows. Of those protrusion dots located outside of the measurement windows, some may be located between two measurement windows. As shown in FIG. 2, the outer diameter of the cylindrical body 110 from the top to the bottom may be substantially the same.

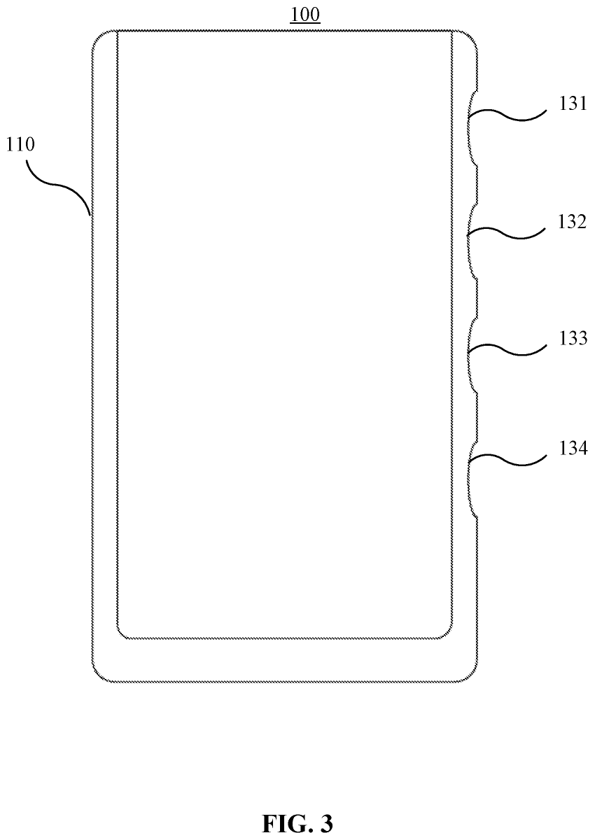

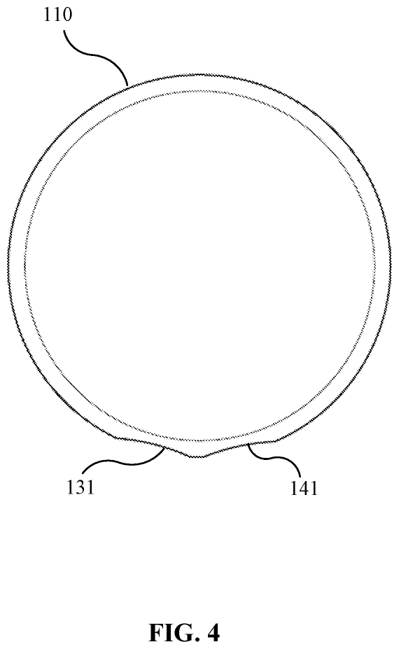

FIG. 3 is a cross-sectional view along the 3-3 line in FIG. 2. FIG. 4 is a cross-sectional view along the 4-4 line in FIG. 2. The concave measurement windows may be about 1-2 millimeters below the exterior surface of the cylindrical body 110. For example, a center point of each concave measurement window may be about 1-2 millimeters lower than the exterior surface of the cylindrical body 110. A measurement marking (e.g., “9,” “7,” “5,” “3,” “240,” “180,” “120,” “60”) may be formed within each concave measurement window.

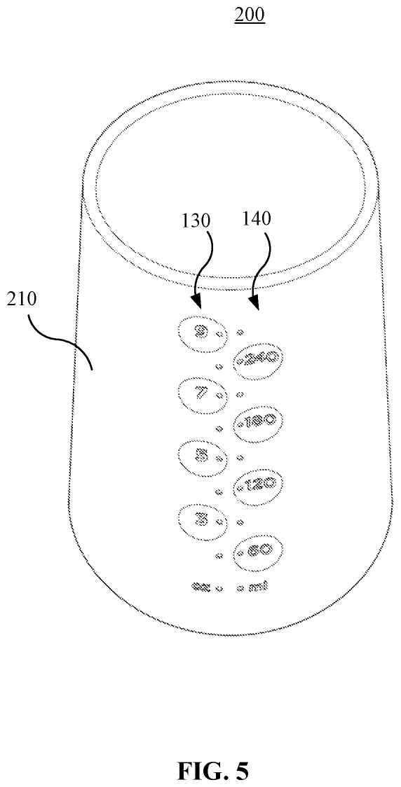

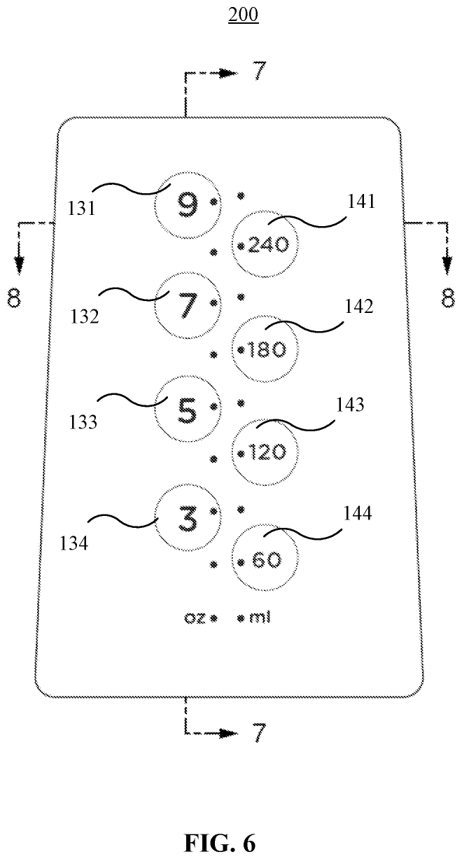

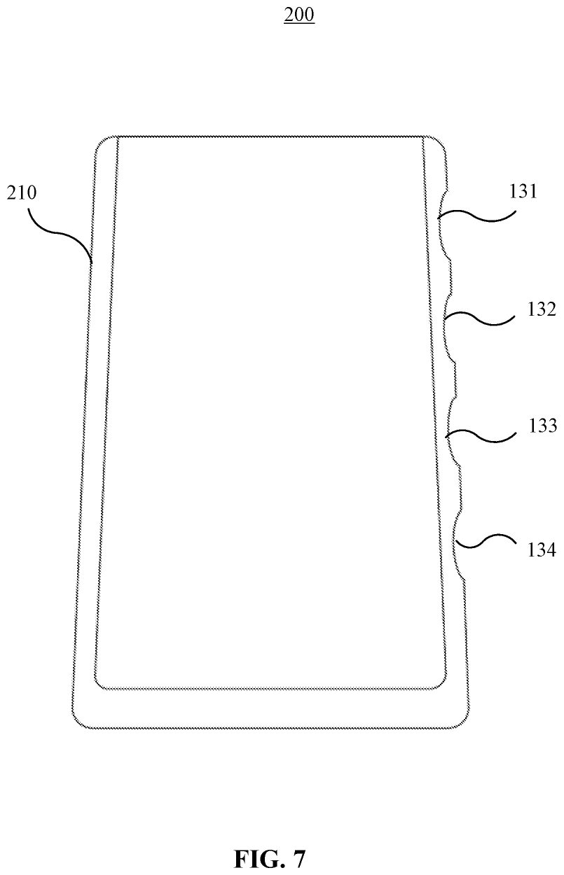

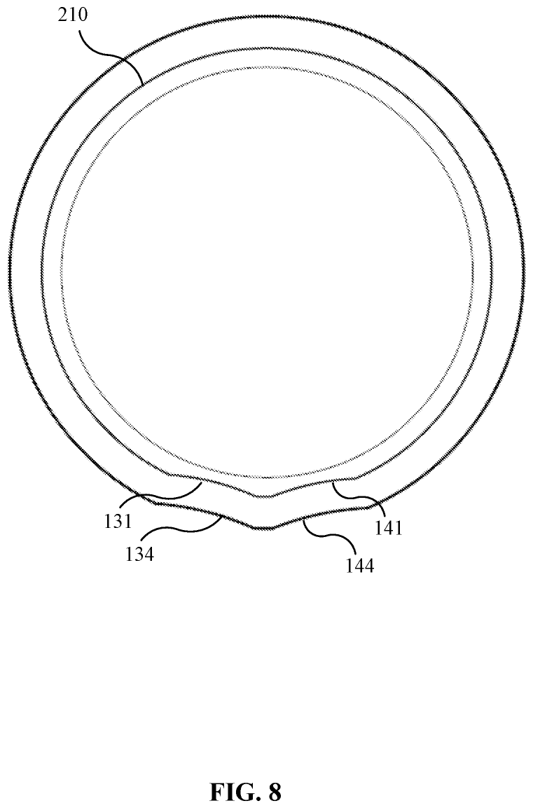

FIG. 5 is a schematic illustration of a perspective view of a silicone cup with concave measurement windows, according to another embodiment of the present disclosure. FIG. 6 is a schematic illustration of a front view of the silicone cup with the concave measurement windows shown in FIG. 5, according to an embodiment of the present disclosure. FIG. 7 is a schematic illustration of a cross-sectional view of the silicone cup with the concave measurement windows along the 7-7 line shown in FIG. 6, according to an embodiment of the present disclosure. FIG. 8 is a schematic illustration of a cross-sectional view of the silicone cup with the concave measurement windows along the 8-8 line shown in FIG. 6, according to an embodiment of the present disclosure.

As shown in FIG. 5, according to another embodiment, a silicone cup 200 may have a body 210 having a conical cylinder shape with a varying outer diameter in the vertical direction. As shown in FIG. 6, the conical cylinder shape may have a trapezoidal cross-section. That is, in some embodiments, the outer diameter at the bottom portion may be larger than the outer diameter at the top portion of the conical cylinder shape. In some embodiments, although not shown, the outer diameter at the bottom portion may be smaller than the outer diameter at the top portion. The concave measurement windows in this embodiment may be similar to those shown in the embodiment of FIG. 1-FIG. 4. Thus, the descriptions of the concave measurement windows shown in FIG. 5-FIG. 8 can refer to the above descriptions of FIG. 1-FIG. 4.

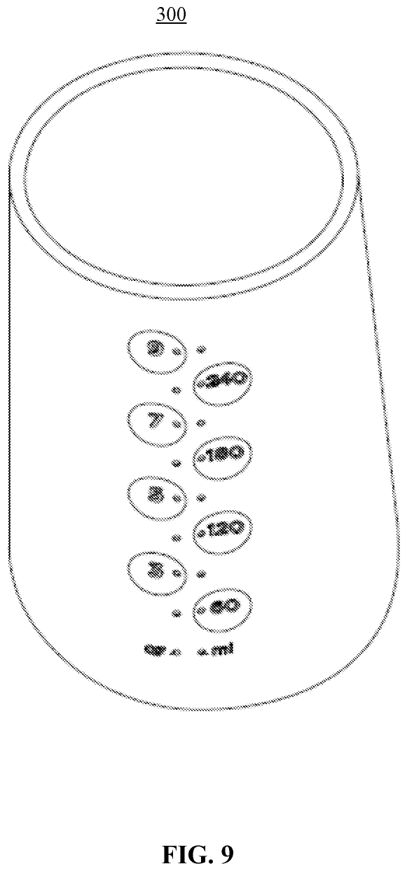

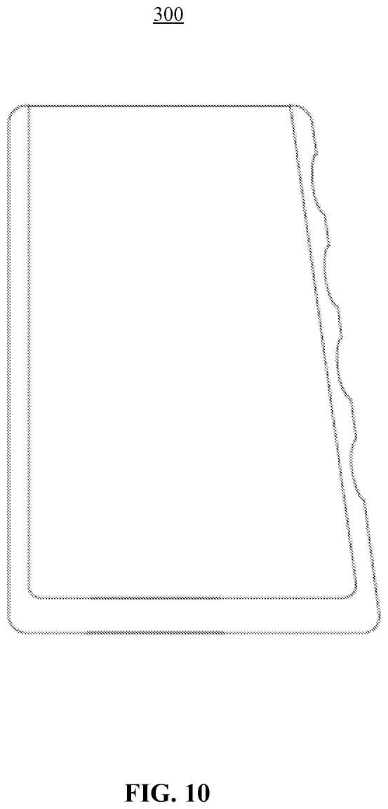

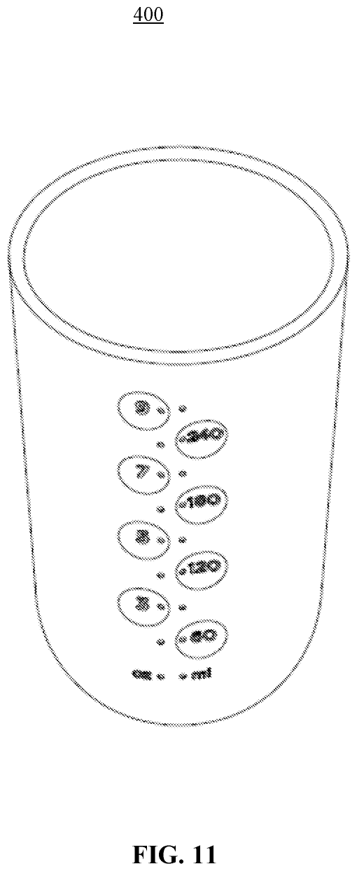

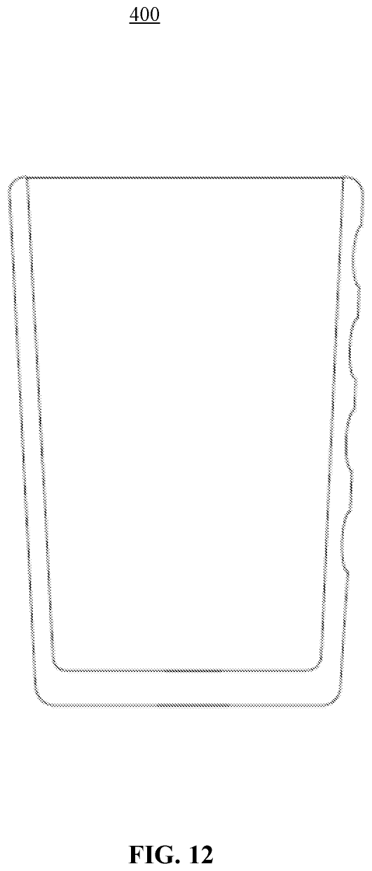

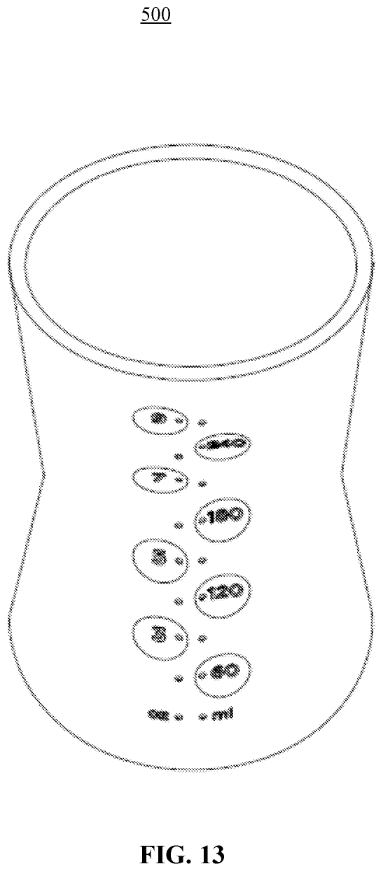

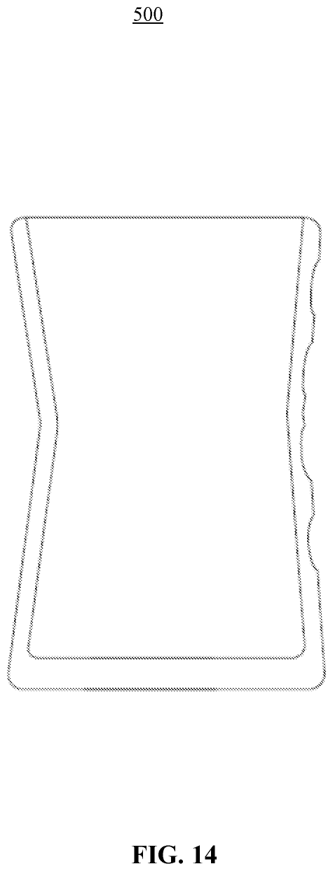

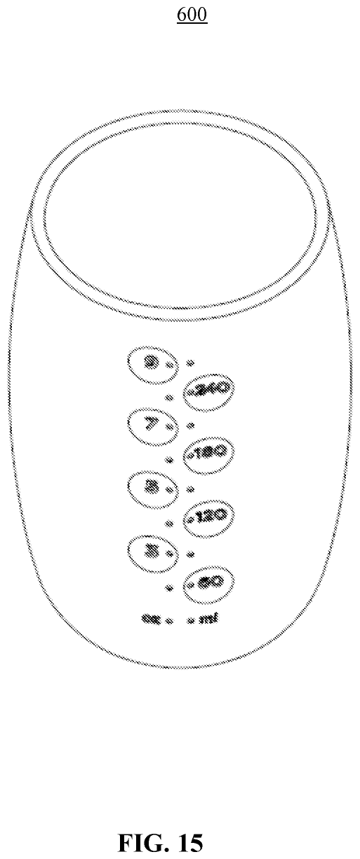

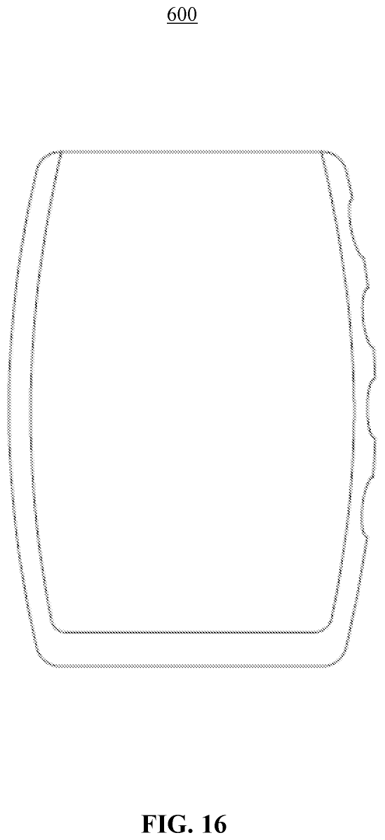

The silicone cup with concave measurement windows may be in other shapes. Additional exemplary shapes are shown in FIG. 9-FIG. 16. FIG. 9 is a schematic illustration of a front to perspective view of a silicone cup with concave measurement windows, according to an embodiment of the present disclosure. FIG. 10 is a schematic illustration of a cross-sectional view of the silicone cup shown in FIG. 9, according to an embodiment of the present disclosure. FIG. 11 is a schematic illustration of a front to perspective view of a silicone cup with concave measurement windows, according to an embodiment of the present disclosure. FIG. 12 is a schematic illustration of a cross-sectional view of the silicone cup shown in FIG. 11, according to an embodiment of the present disclosure. FIG. 13 is a schematic illustration of a front to perspective view of a silicone cup with concave measurement windows, according to an embodiment of the present disclosure. FIG. 14 is a schematic illustration of a cross-sectional view of the silicone cup shown in FIG. 13, according to an embodiment of the present disclosure. FIG. 15 is a schematic illustration of a front to perspective view of a silicone cup with concave measurement windows, according to an embodiment of the present disclosure. FIG. 16 is a schematic illustration of a cross-sectional view of the silicone cup shown in FIG. 15, according to an embodiment of the present disclosure.

As shown in FIG. 9 and FIG. 10, a silicone cup 300 may have a trapezoidal cross-section, with one side being vertically straight (perpendicular to the bottom side), and another side being slanted. As shown in FIG. 11 and FIG. 12, a silicone cup 400 may have another trapezoidal cross-section, with both sides being slanted, and a diameter at the upper opening being greater than a diameter at the bottom side. As shown in FIG. 13 and FIG. 14, a silicone cup 500 may have a crossed (or “X” shaped) cross-section. As shown in FIG. 15 and FIG. 16, a silicone cup 600 may have a barrel shape, with a diameter at a center portion (in vertical direction or height direction) being greatest, greater than diameters at the upper opening and at the bottom side.

The concave measurement windows in the embodiments shown in FIG. 9-FIG. 16 may be similar to those shown in the embodiment of FIG. 1-FIG. 4. Thus, the descriptions of the concave measurement windows shown in FIG. 9-FIG. 16 can refer to the above descriptions of FIG. 1-FIG. 4.

With the transparent concave measurement windows on the silicone body, more light reflection may be provided for the measurement marking. Therefore, the liquid level in the cup may be easily and conveniently identified or recognized. In addition, when the cup 100 is used by a small hand or a weak hand, the concave measurement windows may be grasped by fingers, enhancing the friction and stability. In some situations, the solid protrusions may also help increase the grasping friction.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A silicone cup, comprising:
a body made of a silicone; and
a plurality of concave measurement windows provided on an exterior surface of the body.

2. The silicone cup of claim 1, wherein the plurality of concave measurement windows include a first column of concave measurement windows and a second column of concave measurement windows.

3. The silicone cup of claim 1, wherein a center point of each concave measurement window is about 1-2 millimeters below the exterior surface.

4. The silicone cup of claim 1, wherein each concave measurement window includes a solid protrusion formed on a concave surface of the concave measurement window.

5. The silicone cup of claim 1, wherein the body has a cylinder shape or a conical cylinder shape.
